(19) United States
(12) Patent Application Publication
(10) Pub. No.: US 2003/0039506 A1
(43) Pub. Date: Feb. 27, 2003

(54) Elbow connector structure for a cymbal support

(76) Inventor: Chang Hui Chen, Taipei City (TW)

Correspondence Address: Chang Hui CHEN, PO Box 82-144, TAIPEI, TW

(21) Appl. No.: 09/938,567

(22) Filed: Aug. 27, 2001

(51) Int. Cl. F16D 1/12; F16D 3/00; F16C 11/00

(52) U.S. Cl. 403/96

(57) ABSTRACT

An elbow connector structure for a cymbal support is disclosed. The connector structure has an elbow connector mounted with tooth surface and being secured onto a support. The structure has a rotating elbow seat located at the bottom of a supporting rod for the cymbal, characterized in that the external side of the connector at the bottom end of the supporting rod is protruded with a pivotal lug seat having an arch-shaped plate having a guided sliding hole allowing the insertion of the supporting rod for deviated sliding adjustment, and a screw nut is used to mount the cymbal onto the supporting rod. The structure allows the cymbal to be adjusted at any angle as required by the drummer.

### BACKGROUND OF THE INVENTION

(a) Field of the Invention

The present invention relates to an elbow connector structure, and in particular, an elbow connector, which is used to mount a cymbal, support so that the angle of the cymbal on the support can be easily adjusted in a required position.

(b) Description of the Prior Art

FIGS. 6 and 7 show a conventional elbow connector structure having an upright support 30 connected to an elbow connector 31, having toothed surface 32, being mounted at the head portion of the support 30. A supporting rod 33 being used to secure a cymbal is mounted to the toothed surface of a rotating elbow seat 34 corresponding to the elbow connector 31.

In combination with a spring 35, and a locking nut 36, the angle of the supported cymbal by the elbow connector 31 can be adjusted or changed to an angle required by the drummer. However, the drawback of this conventional structure is that the angle of adjustment or the direction of the angle changed is restricted to a specific angle. If another swinging angle of the cymbal is required, the entire supporting rod 30 has to be rotated but the lateral angle of the cymbal support cannot be adjusted. In other words, the change of angle is restricted to one direction As a result, it is an object of the present invention to provide an elbow connector structure for a cymbal support, wherein the angle of the cymbal mounted onto a supporting rod can be adjusted in any direction.

### SUMMARY OF THE INVENTION

The present invention relates to an elbow connector structure, and in particular, an elbow connector, which is used to mount a cymbal, support so that the angle of the cymbal on the support can be easily adjusted in a required position.

Accordingly, it is an object of the present invention to provide an elbow connector structure for a cymbal support, wherein the external side of the connector at the bottom end of the supporting rod is protruded with a pivotal lug seat having an arch-shaped plate having a guided sliding hole allowing the insertion of the supporting rod for tilted sliding adjustment, and a screw nut is used to mount the cymbal onto the supporting rod.

Yet another object of the present invention to provide an elbow connector structure for a cymbal support, wherein the supporting rod is appropriately adjusted within a sliding hole provided on the elbow seat, thereby, the required angle of adjustment of the cymbal can be easily obtained.

Other object and advantages of the present invention will become more apparent from the following description taken in conjunction with the accompanying drawing.

### BRIEF DESCRIPTION OF THE DRAWINGS

FIG. 1 is a perspective exploded view of an elbow connector structure for a cymbal support of the present invention.

FIG. 2 is a perspective view of an elbow connector structure for a cymbal support of the present invention.

FIG. 3 is a schematic view showing the adjustment of the cymbal mounted onto the elbow connector structure for a cymbal support of the present invention.

FIG. 3A is another perspective view of the elbow connector structure for a cybmal support of the present invention;

FIG. 4 is a front view showing the position of the cymbal supported by an elbow connector structure for a cymbal support of the present invention.

FIG. 5 is a schematic view showing the tilting of the cymbal as a result of the adjustment of the rotating rod in accordance with the present invention.

FIG. 6 is a front view showing the cymbal being adjusted to an angle in accordance with the present invention.

FIG. 7 is a perspective view and a perspective exploded view of a conventional elbow connector being utilized in the cymbal.

### DETAILED DESCRIPTION OF THE PRESENT INVENTION

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

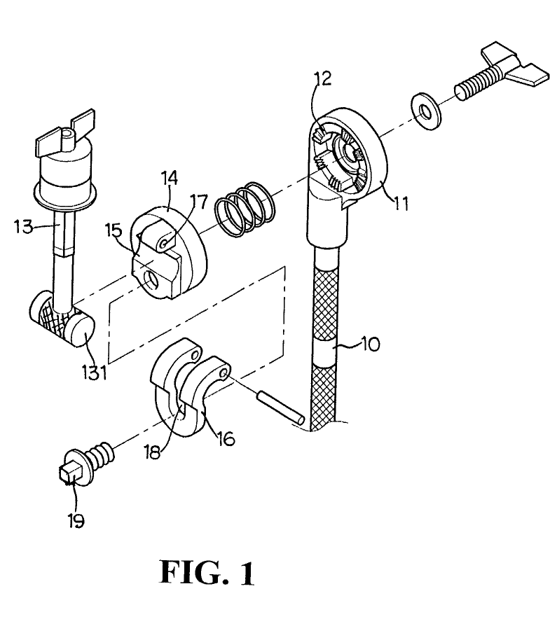

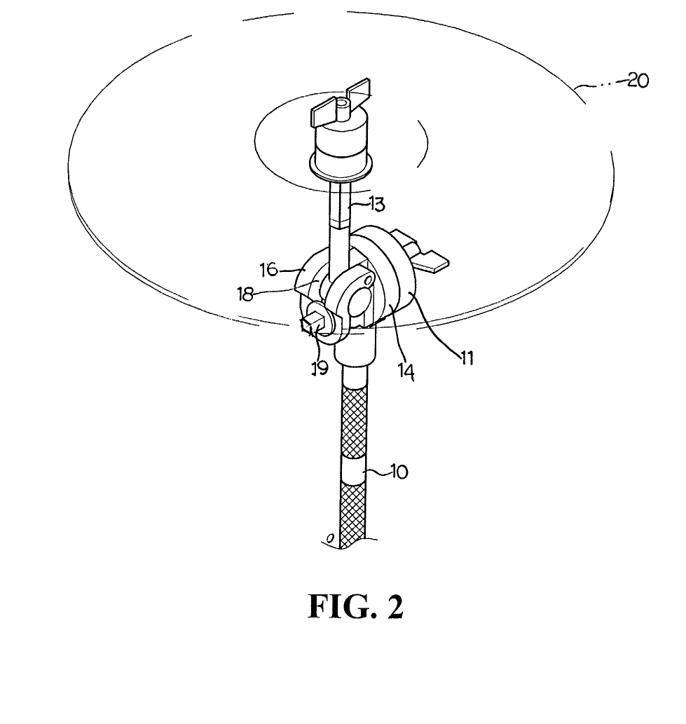

Referring to FIGS. 1 to 5, there is shown an elbow connector structure for a cymbal support to support a cymbal 20. The structure comprises a support 10 having an elbow connector 11 secured at the top end of the support 10, the elbow connector 11 being provided with a teethed surface 12 for positioning by engaging with the top end of the support 10, and a supporting rod 13 for locking with a cymbal 20.

The bottom end of the supporting rod 13 is a shaft 131 and the elbow connector 11 is corresponding to an elbow seat 14. The external side of the elbow seat 14 is provided with a lug seat 15 and a lug plate 16 which is an arch-shaped structure protruded from the side of the seat 14, as shown in FIG. 1. A pivot hole 17 for securing is provided on the external side of the elbow seat 14 such that the lug plate 16 can be pivotally mounted. The lug plate 16 can also be directly connected to the elbow seat 14 and the bottom end thereof is formed into an opening and is elastic. The center of lug plate 16 is provided with a sliding hole 18 and the end of the hole 18 is a u-shaped opening, allowing the insertion of the support rod 13. A screw nut 19 is to be inserted through the U-shaped sliding hole 18 to an aperture provided on the external side of the lug seat 15 so that the lug plate 16 can be positioned onto the elbow seat 14. The adjustment of the screw nut 19 can pivotally adjust the lug seat 15 and thus the supporting rod 13 is positioned. The surface of the shaft 131 at the interior of the lug seat 15 is provided with threaded surface to obtain a rough surface, or to mount with an elastic rubber pad so as to firmly secure the entire structure.

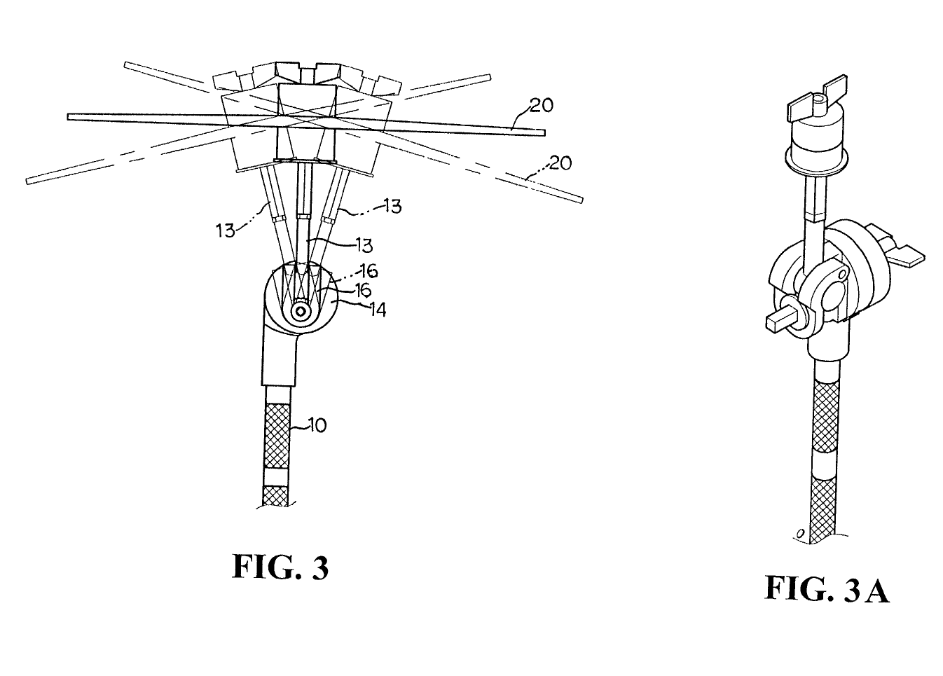

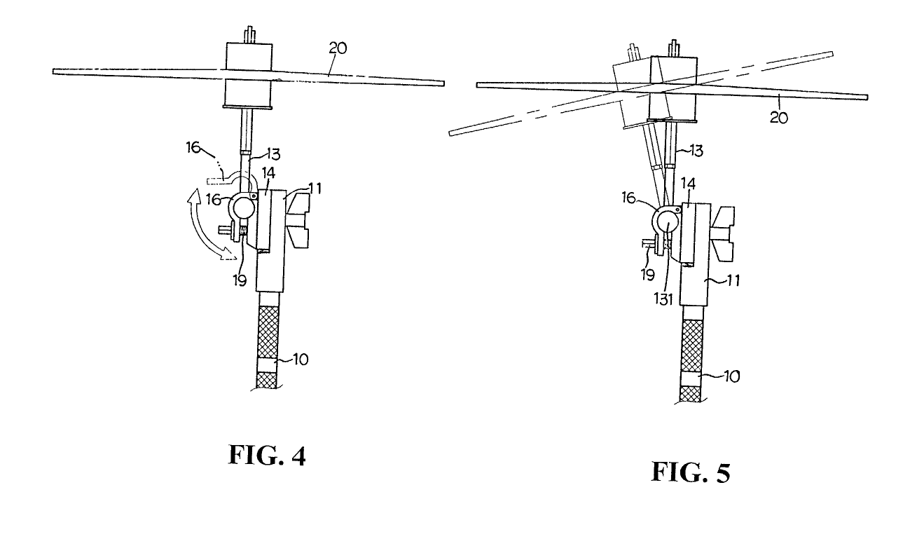

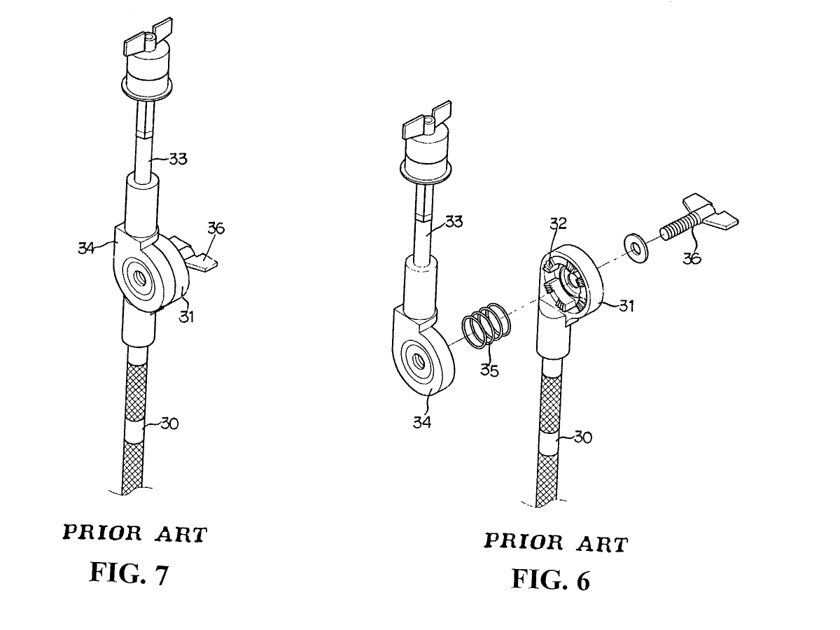

As shown in FIGS. 3 and 3A, when the elbow seat 14 is to be adjusted, the nut 19 is loosened and the supporting rod 13 can be slightly moved along the sliding hole 18, as shown in FIGS. 4 and 5. Thus the swinging angle of the mounted cymbal is adjusted. In combination with the elbow seat 14, the supporting rod 13 can be adjusted to other angle for the beating of a drummer.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

Many other advantages and features of the present invention will become manifest to those versed in the art upon making reference to the detailed description and the accompanying sheets of drawings in which a preferred structural embodiment incorporating the principles of the present invention is shown by way of illustrative example.

I claim:

1. An elbow connector structure for a cymbal support having an elbow connector mounted with toothed surface within the connector and being secured onto a support, and having a rotating elbow seat located at the bottom of a supporting rod for the cymbal, characterized in that the external side of the connector at the bottom end of the supporting rod is protruded with a pivotal lug seat having an arch-shaped plate having a guided sliding hole allowing the insertion of the supporting rod for tilted sliding adjustment, and a screw nut is used to mount the cymbal onto the supporting rod.

2. The elbow connector structure for a cymbal support of claim 1, wherein the sliding hole is provided at one end of the lug plate and is a U-shaped opening.

3. The elbow connector structure for a cymbal support of claim 1, wherein the pivotal lug plate is pivotally connected to a pivotal hole at the outer side of the elbow seat or directly connected with the elbow seat to form an elastic combination.

4. The elbow connector structure for a cymbal support of claim 1, wherein the ring surface for the locking shaft at the bottom end of the supporting rod and the ring face locked with the lug plate are rough surface, or are directly mounted with elastic rubber facilitating securing.
